(19) United States
(12) Patent Application Publication
(10) Pub. No.: US 2014/0119273 A1
(43) Pub. Date: May 1, 2014

(54) WIRELESS COMMUNICATION APPARATUS, WIRELESS COMMUNICATION SYSTEM AND METHOD FOR WIRELESS COMMUNICATION

(71) Applicant: KABUSHIKI KAISHA TOSHIBA, Tokyo (JP)

(72) Inventor: Kengo Kurose, Hamura-shi (JP)

(73) Assignee: KABUSHIKI KAISHA TOSHIBA, Tokyo (JP)

(21) Appl. No.: 14/030,957

(22) Filed: Sep. 18, 2013

(30) Foreign Application Priority Data
Oct. 31, 2012 (JP) 2012-240582

(51) Int. Cl. H04W 72/12

(52) U.S. Cl. CPC H04W 72/1226
USPC 370/315

(57) ABSTRACT

According to one embodiment, a wireless communication apparatus includes a repeater and a controller. The repeater includes first and second wireless communication modules capable of performing a wireless communication with synchronized with each other and relay wireless communication between first and second wireless communication devices. The controller detects transmission/reception timing of the first wireless communication module and controls transmission/reception timing of the second wireless communication module based on the detected timing to suppress interference caused by transmission from the second wireless communication module during reception of the first wireless communication module.

### CROSS-REFERENCE TO RELATED APPLICATIONS

This application is based upon and claims the benefit of priority from Japanese Patent Application No. 2012-240582, filed Oct. 31, 2012, the entire contents of which are incorporated herein by reference.

### FIELD

Embodiments described herein relate generally to a wireless communication apparatus, a wireless communication system, and a method for wireless communication.

### BACKGROUND

In recent years, a video transmission system that transmits video (possibly including audio) captured by, for example, a doorphone camera using a method for short-range wireless communication such as Bluetooth (registered trademark) has been developed for practical use.

While the communication rate of Bluetooth is relatively low, the profile thereof is defined for each field of use and the application range thereof is advantageously wide. The video distribution profile (VDP) is defined for a video transmission system.

A short-range wireless communication system involving Bluetooth or the like requires a relay station to extend the communication range. For example, a system that transmits video from a doorphone camera into a residence requires a relay station inside the residence. Because the communication rate of Bluetooth or the like is low, it is difficult to ensure the communication speed when a repeater constituting a relay station is realized by a wireless communication module.

That is, in a video transmission system to which, for example, a VDP is applied, the transmitting side becomes a master and the receiving side becomes a slave. More specifically, when a camera is the master that transmits video, a repeater becomes a slave as the receiving side. On the other hand, the repeater becomes a master that transmits received video to, or example, a video reproduction apparatus. In this case, a repeater of one wireless communication module cannot function as a master and a slave simultaneously and thus, the communication speed when video is transmitted the camera to the video reproduction apparatus is half the speed. Thus, realizing the repeater by using two wireless communication modules is considered.

In a short-range wireless communication system involving Bluetooth or the like, it is desirable to realize a repeater by using two wireless communication modules to avoid a lower communication speed. However, if two wireless communication modules are mounted inside the repeater, the transmitted radio signals from both modules have a mutual influence as interference signals, causing the problem that it becomes difficult to perform wireless communication such as video transmission.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing the configuration of a wireless communication system according to an embodiment;

FIGS. 2A, 2B and 2C are diagrams illustrating an example of transmission/reception timing of a Bluetooth wireless communication method according to the embodiment;

FIGS. 3A, 3B, 3C and 3D are diagrams illustrating an example of the transmission/reception timing of the Bluetooth wireless communication method according to the embodiment;

FIGS. 4A, 4B, 4C and 4D are diagrams illustrating the transmission/reception timing of a repeater according to the embodiment;

FIGS. 5A, 5B, 5C and 5D are diagrams illustrating the transmission/reception timing of a relay station according to the embodiment;

FIGS. 6A, 6B, 6C and 6D are diagrams illustrating the transmission/reception timing of the relay station according to the embodiment;

FIGS. 7A, 7B, 7C and 7D are diagrams illustrating the transmission/reception timing of the repeater according to the embodiment; and

FIG. 8 is a flowchart illustrating the operation of the repeater according to the embodiment.

### DETAILED DESCRIPTION

Various embodiments will be described hereinafter with reference to the accompanying drawings.

In general, according to one embodiment, a wireless communication apparatus includes a repeater and a controller. The repeater includes first and second wireless communication modules capable of performing a wireless communication operation by being synchronized with each other and relays wireless communication between a first wireless communication device and a second wireless communication device. The controller detects transmission/reception timing of the first wireless communication module and controls transmission/reception timing of the second wireless communication module based on the detected transmission/reception timing to suppress interference caused by transmission from the second wireless communication module during reception of the first wireless communication module.

[Configuration of a Wireless Communication System]

As shown in FIG. 1, a wireless communication system according to the present embodiment constitutes, for example, a video transmission system that transmits video (including audio) from a camera 20 to a video reproduction device 30. The wireless communication system according to the present embodiment includes a repeater 10 that relays between a wireless communication module 21 of the camera 20 and a wireless communication module 31 of the video reproduction device 30.

The repeater 10 includes a first wireless communication module 11A and a second wireless communication module 11B and the wireless communication modules 11A, 11B are synchronized for transmission/reception of data. The wireless communication modules 11A, 11B contain controllers 12A, 12B to control transmission/reception of data respectively. The wireless communication modules 11A, 11B are each Bluetooth (registered trademark) modules.

The camera 20 is, for example, a doorphone camera and transmits video (including audio) obtained by capturing an outer perimeter of the door by the contained wireless communication module 21. The wireless communication module 21 is a Bluetooth module.

The video reproduction device 30 is provided, for example, in a residence together with the repeater 10. The video reproduction device 30 performs reproduction processing of video transmitted from the camera 20 by being relayed via the repeater 10 and outputs and displays the video on a display 32. The video reproduction device 30 contains the wireless communication module 31 as a Bluetooth module. More specifically, the video reproduction device 30 is, for example, a digital photoframe or a personal computer.

[Operation of a Wireless Communication System and the Repeater 10]

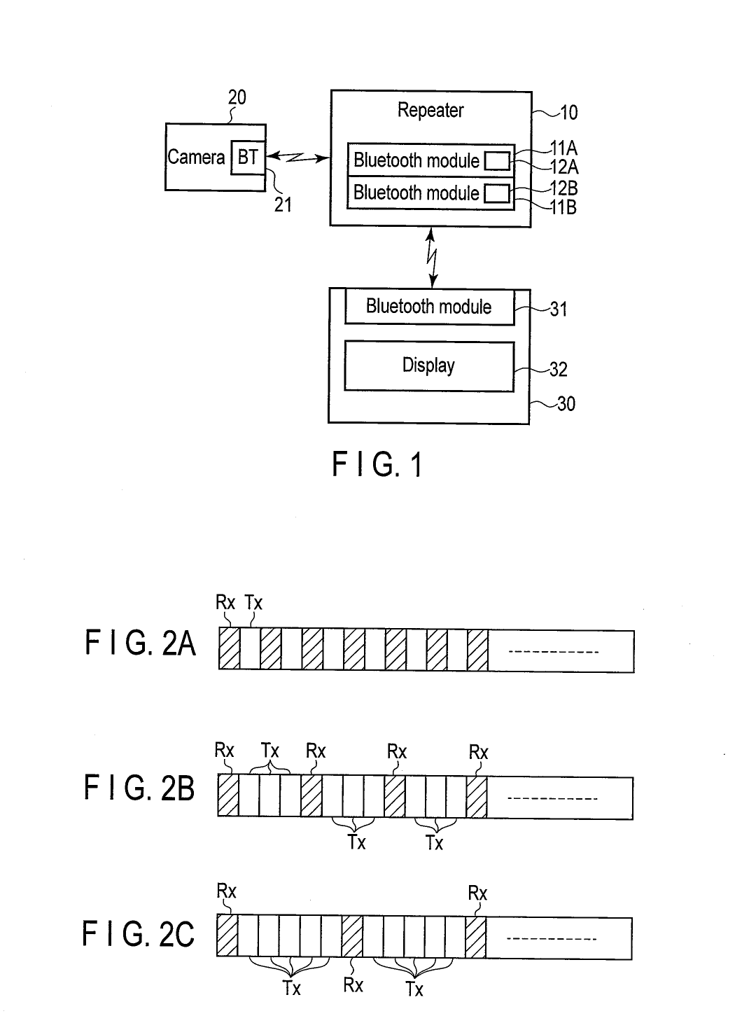

The operation of a wireless communication system according to the present embodiment and the repeater 10 will be described below with reference to FIGS. 2 to 8.

A wireless communication system according to the present embodiment is a case when a video transmission system that transmits video from the camera 20 is constructed by applying a Bluetooth video distribution profile (VDP). FIGS. 2A to 2C show general transmission/reception timing in the Bluetooth wireless communication scheme. In FIGS. 2A to 7D, Tx indicates transmission and Rx indicates reception.

In the Bluetooth wireless communication scheme, when the master transmits a packet (data transmission unit) for one time slot, a packet for one time slot may be returned from a slave. In this case, as shown in FIG. 2A, there is a rule to set odd time slots (not all odd time slots) as Rx slots. To improve the speed of wireless communication by maintaining the rule, as shown in FIG. 2B, there is a mode in which the Tx slots are consecutive for three time slots. Similarly, as shown in FIG. 2C, there is a mode in which the Tx slots are consecutive for five time slots.

The repeater 10 in the present embodiment contains, as described above, two Bluetooth modules, the first wireless communication module 11A and the second wireless communication module 11B. The repeater 10 operates Bluetooth modules 11A and 11B simultaneously to avoid a reduced communication rate. Thus, the repeater 10 can function as master and slave simultaneously. However, as described above, there is a possibility that radio interference, in which the transmitted radio signals of both modules have a mutual influence as interference signals, arises.

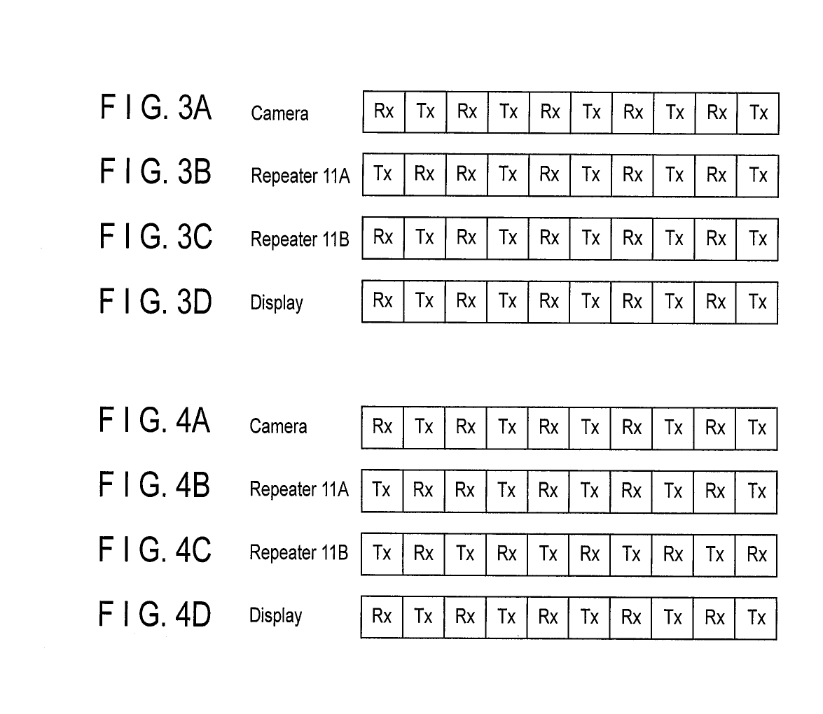

More specifically, this is a case when one Bluetooth module transmits a signal, while the other Bluetooth module is in a receiving state. FIGS. 3B and 3C show the transmission/reception timing of the repeater 10 in one-slot mode. FIG. 3A shows the transmission/reception timing of the wireless communication module 21 contained in the camera 20. FIG. 3D shows the transmission/reception timing of the wireless communication module 31 of the video reproduction device 30.

If a transmission/reception timing mismatch occurs inside the repeater 10, the transmission/reception timing of the first Bluetooth module 11A and the transmission/reception timing of the second Bluetooth module 11B may be totally reversed. More specifically, this is a case when, for example, as shown in FIGS. 3B and 3C, the second Bluetooth module 11B is in Tx timing to transmit a signal, while the first Bluetooth module 11A in Rx timing to receive a video signal transmitted from the camera 20. In this case, there is a possibility that, because of interference from the radio signal transmitted from the second Bluetooth module 11B, the first Bluetooth module 11 becomes incapable of receiving the video signal transmitted from the camera 20.

Thus, the repeater 10 according to the present embodiment exercises control to match the transmission/reception timing of the first Bluetooth module 11A and the transmission/reception timing of the second Bluetooth module 11B in one-slot mode in which the Tx slot is allocated to one time slot. In other words, the repeater 10 according to the present embodiment controls the transmission/reception timing to reduce the influence of interference due to the radio signal transmitted from Bluetooth module 11B when, for example, Bluetooth module 11A receives a video signal transmitted from the camera 20.

FIG. 4A shows the transmission/reception timing of the wireless communication module 21 contained in the camera 20. FIG. 4D shows the transmission/reception timing of the wireless communication module 31 of the video reproduction device 30.

More specifically, as shown in FIGS. 4B and 4C, for example, the Tx timing of the first Bluetooth module 11A and the Tx timing of the second Bluetooth module 11B are matched. Also, the second Bluetooth module 11B matches the Rx timing during Rx timing in which the first Bluetooth module 11A receives a video signal transmitted from the camera 20. Accordingly, for example, as shown in FIGS. 4B and 4C, the first Bluetooth module 11A can reduce the likelihood of becoming incapable of receiving because of interference from a radio signal transmitted from the second Bluetooth module 11B in the Rx timing when a video signal transmitted from the camera 20 is received.

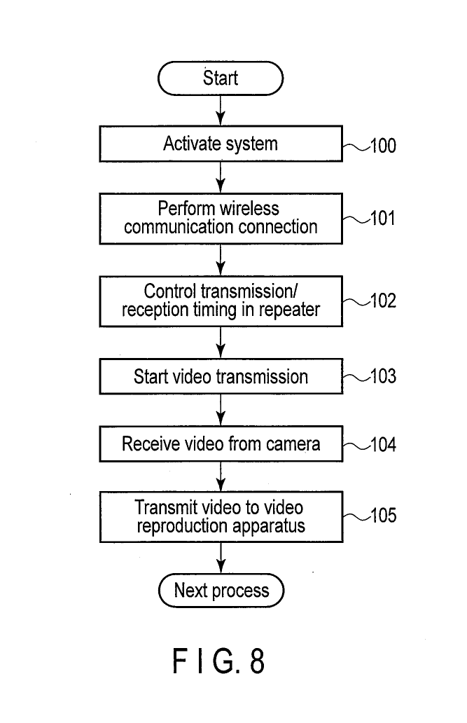

The operation of the repeater 10 according to the present embodiment in the video transmission system shown in FIG. 1 will concretely be described with reference to the flowchart in FIG. 8.

In the video transmission system according to the present embodiment, the camera 20 installed, for example, in the main entrance of the residence and video (including audio) obtained by capturing an outer perimeter of the door is transmitted by the wireless communication module 21. The repeater 10 and the video reproduction device 30 are fixedly arranged, for example, inside a room of the residence.

The video transmission system according to the present embodiment transmits video by means of the Bluetooth wireless communication scheme. The Bluetooth wireless communication scheme is a piconet connection scheme. Therefore, in the video transmission system according to the present embodiment, Bluetooth modules 21, 11A, 11B, and 31 of the camera 20, the repeater 10, and the video reproduction device 30 are connected for wireless communication by the procedure of a piconet internal link in the Bluetooth wireless communication scheme.

In the Bluetooth wireless communication scheme, packets (data transmission unit) of video and the like are transmitted to each slave via the master (changeable). That is, in the video transmission system according to the present embodiment, for example, the repeater 10 as the master receives video (packet) transmitted from the camera 20 as a slave and transmits the video to the video reproduction device 30 as a slave.

As shown in the flowchart in FIG. 8, the video transmission system according to the present embodiment is activated by, for example, a doorphone switch being turned on (block 100). In the Bluetooth wireless communication scheme, each slave operates in synchronization with the master. That is, before wireless communication is started, the doorphone is the master and the repeater 10 operates in synchronization with transmission from the doorphone. Similarly, Bluetooth modules 21 and 31 of the camera 20 and the video reproduction device 30 operate in synchronization with transmission from the doorphone.

More specifically, for example, the master transmits an ID (identification) packet having access code to each slave. The master confirms a reception response by receiving the ID packet returned by each slave. The repeater 10 according to the present embodiment contains the first and second Bluetooth modules 11A and 11B. Therefore, each of Bluetooth modules 11A and 11B receives the ID packet transmitted from the doorphone as the master. By performing the above procedure, the video transmission system according to the present embodiment completes Bluetooth wireless communication connection (block 101).

Next, when the wireless communication is started, the repeater 10 controls the transmission/reception timing of the first and second Bluetooth modules 11A and 11B (block 102). That is, the second Bluetooth module 11B of the repeater 10 performs, for example, synchronization processing with the first Bluetooth module 11A operating as the master. More specifically, the controller 12B of Bluetooth module 11B detects the transmission/reception timing (Tx, Rx) of Bluetooth module 11A. The controller 12B exercises control in order to operate in the transmission/reception timing (Tx, Rx) matching the transmission/reception timing of Bluetooth module 11A. More specifically, the second Bluetooth module 11B matches the Rx timing during Rx timing in which the first Bluetooth module 11A receives a video signal transmitted from the camera 20.

Synchronization processing between Bluetooth modules 11A and 11B of the repeater 10 is performed by a concrete method described below.

In the Bluetooth wireless communication scheme, the master transmits an ID packet having access code and clock information to each slave. The clock information is information such as the frequency that decides the timing (Tx, Rx) of Bluetooth wireless communication. Each slave calculates a difference of the clock information of the slave based on the clock information from the master and synchronizes with the master by storing the clock offset. Normally, the time accuracy of the clock offset is 1.25 ms. In this case, because synchronization with an accuracy enabling slot synchronization is needed, when an ID packet having access code transmitted from the master is received, each slave synchronizes with an accuracy of 1 μsec based on an output result in the correlation period for the synchronization preamble of the ID packet.

By performing the above processing, the repeater 10, the camera 20, and the video reproduction device 30 are each connected by Bluetooth wireless communication and the video transmission system according to the present embodiment starts video transmission that transmits video from the camera 20 to the video reproduction device 30 (block 103).

Bluetooth modules 11A and 11B of the repeater 10 operate simultaneously in the same transmission/reception timing (Tx, Rx) as the master or a slave. That is, for example, Bluetooth module 11A performs wireless communication with Bluetooth module 21 of the camera 20 to receive video from the camera 20. At the same time, Bluetooth module 11B performs wireless communication with Bluetooth module 31 of the video reproduction device 30 to transmit received video.

That is, the repeater 10 receives the video transmitted from the camera 20 (block 104). Further, the repeater 10 performs the relay that transmits the received video to the video reproduction device 30 (block 105). The video reproduction device 30 outputs and displays the video relayed by the repeater 10 on the display 32. Accordingly, an occupant of the residence can check a person at the main entrance from the video displayed in the display 32.

As described above, the repeater 10 according to the present embodiment can perform relay processing without causing a lower communication rate by operating the first and second Bluetooth modules 11A and 11B in synchronization. In this case, the repeater 10 controls the transmission/reception timing (Tx, Rx) in order to reduce the influence of interference due to a signal transmitted from Bluetooth module 11B when, for example, Bluetooth module 11A as the master receives video transmitted from the camera 20. Therefore, the repeater 10 according to the present embodiment can realize a reliable relay operation.

The Bluetooth wireless communication system is a wireless communication system capable of controlling transmission power. Thus, if the transmission environment (transmission loss) of each Bluetooth module is small, transmission power is minimized thanks to power saving. In this case, as described above, mutual interference inside the repeater 10 may not occur. Therefore, the repeater 10 may be configured to monitor an error rate of each of Bluetooth modules 11A and 11B and apply the transmission/reception timing control according to the present embodiment when the error rate is equal to or more than a certain threshold. Alternatively, the repeater 10 may be configured to specify transmission power that affect reception characteristics because of mutual interference inside the repeater 10 in advance and apply the transmission/reception timing control according to the present embodiment when transmission power equal to or more than the threshold is set.

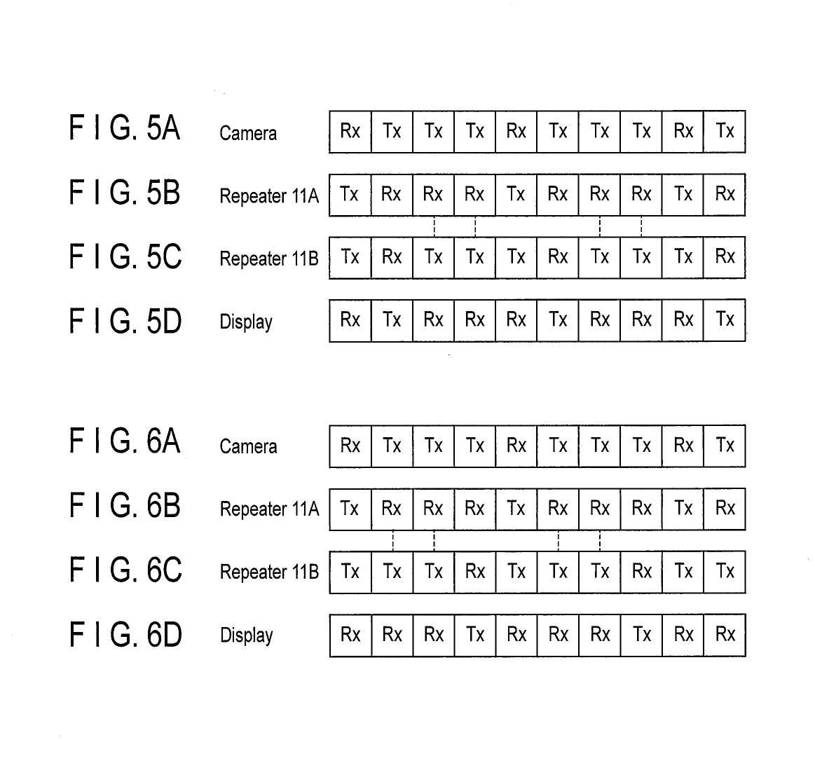

The present embodiment described above is a case when the repeater 10 operates in one-slot mode in which the Tx slot is allocated to one time slot. When, as shown in FIGS. 5A to 5D, 6A to 6D, the repeater 10 operates in three-slot mode in which the Tx slot is allocated to three time slots, interference from a signal transmitted from one Bluetooth module may not be completely avoided when consecutive Tx slots occur.

More specifically, as shown in FIG. 5C, this is a case when the second Bluetooth module 11B transmits consecutive Tx slots. In this case, as indicated by dotted lines in FIGS. 5B and 5C, the first Bluetooth module 11A is likely to be subject to interference by a signal transmitted from the second Bluetooth module 11B when receiving video transmitted from the camera 20.

Similarly, as indicated by dotted lines in FIGS. 6B and 6C, the first Bluetooth module 11A is likely to be subject to interference by a signal transmitted from the second Bluetooth module 11B when receiving video transmitted from the camera 20.

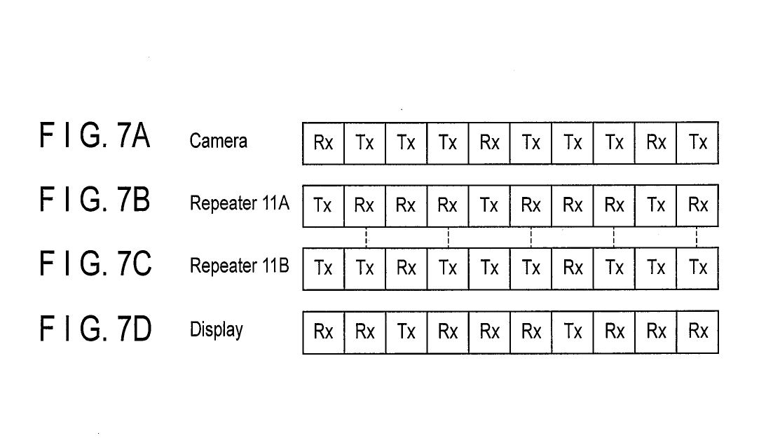

Thus, as indicated by dotted lines in FIGS. 7B, 7C, in a Bluetooth wireless communication system in which data medium rate (DM) packets on which specifically error correction coding is performed are transmitted and received, the influence of an interference signal can be avoided in consecutive slots by performing interleaving for error correction. When such control is exercised, it is desirable to fix the number of transmission slots. In addition, a specific transmission slot mode may be fixed through negotiations between the repeater 10 and the doorphone as the master when a wireless connection is established in the present embodiment.

To sum up, the repeater 10 in a Bluetooth wireless communication system according to the present embodiment can suppress avoidance of mutual radio interference when Bluetooth modules in the repeater are operated simultaneously. Therefore, the Bluetooth modules can operate simultaneously and, in contrast to the time division operation, a reliable relay can be realized without causing a lower communication speed. Accordingly, when a repeater according to the present embodiment is applied to a Bluetooth wireless communication system, the communication speed can be guaranteed and an increased communication range can be realized reliably.

The various modules of the systems described herein can be implemented as software applications, hardware and/or software modules, or components on one or more computers, such as servers. While the various modules are illustrated separately, they may share some or all of the same underlying logic or code. While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wireless communication apparatus comprising:
a repeater comprising first and second wireless communication transceivers configured to perform a wireless communication operation to relay wireless communication between a first wireless communication device and a second wireless communication device; and
a controller configured to detect transmission/reception timing of the first wireless communication transceiver and to control the transmission/reception timing of the second wireless communication transceiver based on the detected transmission/reception timing to suppress interference caused by transmission from the second wireless communication transceiver during reception of the first wireless communication module.

2. The wireless communication apparatus of claim 1, wherein
a wireless communication scheme conforms to the Bluetooth standard.

3. The wireless communication apparatus of claim 1, wherein
the controller is configured to control the transmission/reception timing of the second wireless communication transceiver when the repeater operates in one-slot mode in which a transmission slot of a relayed packet is allocated to one time slot.

4. The wireless communication apparatus of claim 1, wherein
the repeater is configured to receive a packet containing clock information and access code transmitted from a master device and to perform wireless communication connection between the first wireless communication device and the second wireless communication device based on the packet, and
the controller is configured to detect the transmission/reception timing of the first wireless communication transceiver based on the packet and to control the transmission/reception timing of the second wireless communication transceiver based on the detected transmission/reception timing.

5. The wireless communication apparatus of claim 1, wherein
the controller is configured to control the transmission/reception timing of the second wireless communication transceiver when the repeater operates in multislot mode in which a transmission slot of a relayed packet is allocated to a plurality of time slots, and
the controller is configured to control reduction of an influence of interference caused by transmission from the second wireless communication transceiver in the consecutive time slots by interleaving for error correction when the wireless communication device operates in the multislot mode in which the transmission slot of the relayed packet is allocated to a plurality of time slots.

6. The wireless communication apparatus of claim 1, wherein
the repeater comprises the controller, and
the controller is configured to detect the transmission/reception timing of the first wireless communication transceiver when the first wireless communication transceiver starts a wireless communication operation, and to control the transmission/reception timing of the second wireless communication transceiver during reception of the first wireless communication transceiver based on the detected transmission/reception timing.

7. A wireless communication system comprising:
a first wireless communication device;
a second wireless communication device;
a repeater comprising first and second wireless communication transceivers configured to perform a wireless communication operation to relay wireless communication between the first wireless communication device and the second wireless communication device; and
a controller configured to detect transmission/reception timing of the first wireless communication transceiver and to control the transmission/reception timing of the second wireless communication transceiver based on the detected transmission/reception timing to suppress interference caused by transmission from the second wireless communication transceiver during reception of the first wireless communication transceiver.

8. The wireless communication system of claim 7, wherein
a wireless communication scheme conforms to the Bluetooth standard.

9. The wireless communication apparatus of claim 7, wherein
the repeater comprises the controller, and
the controller is configured to detect the transmission/reception timing of the first wireless communication transceiver when the first wireless communication transceiver starts a wireless communication operation, and to control the transmission/reception timing of the second wireless communication transceiver during reception of the first wireless communication transceiver based on the detected transmission/reception timing.

10. A method of wireless communication, for a repeater comprising first and second wireless communication transceivers configured to perform a wireless communication operation to relay wireless communication between a first wireless communication device and a second wireless communication device, the method comprising:
detecting transmission/reception timing of the first wireless communication transceiver; and
controlling the transmission/reception timing of the second wireless communication transceiver based on the detected transmission/reception timing to suppress interference caused by transmission from the second wireless communication transceiver during reception of the first wireless communication transceiver.
